(19) United States
(12) Patent Application Publication
(10) Pub. No.: US 2020/0204537 A1
(43) Pub. Date: Jun. 25, 2020

(54) RELAY APPARATUS, RELAY METHOD, AND COMPUTER READABLE MEDIUM

(71) Applicant: MITSUBISHI ELECTRIC CORPORATION, Tokyo (JP)

(72) Inventors: Tsuguya OISHI, Tokyo (JP); Naoki ITO, Tokyo (JP)

(73) Assignee: MITSUBISHI ELECTRIC CORPORATION, Tokyo (JP)

(21) Appl. No.: 16/333,550

(22) PCT Filed: Nov. 28, 2016
(86) PCT No.: PCT/JP2016/085182

§ 371 Date: Mar. 14, 2019

(51) Int. Cl. H04L 29/06; H04J 3/06; H04L 12/417

(52) U.S. Cl. CPC H04L 63/0807; H04L 12/417; H04J 3/0652

(57) ABSTRACT

A first reception unit (1104) receives first data from a node 1 by a time-triggered scheme, and a second reception unit (1106) receives second data and a token from a node 2 by a token-passing scheme. A first transmission unit (1105) transmits the second data to the node 1, and a second transmission unit (1107) transmits the first data to the node 2 while holding the token. A reference-time management unit (1103) acquires, as a reference time, a time from reception of the first data while the second transmission unit holds the token to next reception of the token by the second reception unit. A communication control unit (1102) causes the first data to be repeatedly received at a communication cycle equal to or longer than the reference time and shorter than an allowable holding time of the token, causes the second data to be repeatedly transmitted at the communication cycle, and every time the token is received, causes the second transmission unit to hold the token until the first data is transmitted to the node 2 within a range of the allowable holding time.

### TECHNICAL FIELD

The present invention relates to a technique of relaying data.

### BACKGROUND ART

In an FA (Factory Automation) network system, a fixed-cycle communication is performed. In the fixed-cycle communication, communication is performed for each communication cycle decided for control of nodes. As a method of the fixed-cycle communication, there exist a time-triggered scheme and a token-passing scheme. In the time-triggered scheme, data transmission is performed with a transmission interval pre-scheduled for each node. In the token-passing scheme, a token is sequentially passed to each of a plurality of nodes, and only a node having acquired the token acquires the transmission right of data. Only a node having the transmission right transmits data.

A relay apparatus that relays a network that performs communication by the time-triggered scheme and a network that performs communication by the token-passing scheme has a communication interface with the network that performs communication by the time-triggered scheme and a communication interface with the network that performs communication by the token-passing scheme. The relay apparatus performs communication by the time-triggered scheme by one of the communication interfaces and performs communication by the token-passing scheme by the other communication interface.

Patent Literature 1 describes a method of suppressing a relay delay at the time of relaying communication between a network that performs communication by the time-triggered scheme and a network that performs communication by an event-driven scheme.

In Patent Literature 1, specifically, a node by the event-driven scheme receives a synchronizing frame having a high priority, which is regularly transmitted from a node by the time-triggered scheme. The node by the event-driven scheme transmits data at a reception timing of the synchronizing frame. Accordingly, a transmission interval of data from the node by the event-driven scheme becomes substantially constant. Based on the transmission interval of the node by the event-driven scheme, a transmission interval of data is set to the relay apparatus and a relay delay is suppressed.

### CITATION LIST

### Patent Literature

Patent Literature 1: JP 2011-109452 A

### SUMMARY OF INVENTION

### Technical Problem

A case where the method described in Patent Literature 1 is applied to a relay apparatus that relays a network by the time-triggered scheme and a network by the token-passing scheme is considered.

In the token-passing scheme, the relay apparatus can transmit data from the node by the time-triggered scheme to the node by the token-passing scheme only while the relay apparatus holds a token. The node by the time-triggered scheme cannot ascertain the timing at which the relay apparatus holds the token. Therefore, it is difficult for the node by the time-triggered scheme to transmit data to the relay apparatus in accordance with the timing at which the relay apparatus holds the token.

Further, the relay apparatus can transmit data from the node by the token-passing scheme to the node by the time-triggered scheme only when a transmission timing in the time-triggered scheme has come. As described above, the node by the token-passing scheme can transmit data only while holding the token. Therefore, it is difficult for the node by the token-passing scheme to transmit data to the relay apparatus in accordance with the timing at which the relay apparatus transmits data to the node by the time-triggered scheme.

Even if the node by the time-triggered scheme can transmit data to the relay apparatus in accordance with the timing at which the relay apparatus holds the token, and the node by the token-passing scheme can transmit data to the relay apparatus in accordance with the timing at which the relay apparatus transmits data to the node by the time-triggered scheme, if a temporary delay occurs in the network by the token-passing scheme, a relay delay occurs. That is, a mismatch occurs between the communication timing of the node by the time-triggered scheme and the communication timing of the node by the token-passing scheme. If a mismatch occurs between the communication timings thereof, a relay delay remains unless a cycle time (a communication cycle) is changed in the network by the time-triggered scheme.

A relay delay in the case where a temporary delay occurs in the network by the token-passing scheme is described with reference to FIG. 8.

In FIG. 8, a node 1 (201) is a communication device compatible with the time-triggered scheme. A node 2 (202) is a communication device compatible with the token-passing scheme. A relay apparatus 200 relays communication between the node 1 (201) and the node 2 (202).

Further, an I/F 1 of the relay apparatus 200 is a communication interface compatible with the time-triggered scheme. An I/F 2 of the relay apparatus 200 is a communication interface compatible with the token-passing scheme.

The node 2 (202) transmits data 801 to the relay apparatus 200 while holding the token. The relay apparatus 200 receives the data 801. The relay apparatus 200 transmits the data 801 as the data 802 to the node 1 (201) when the transmission timing in the time-triggered scheme has come. At this stage, there is little delay between reception of data 801 and transmission of data 802.

The node 1 (201) transmits data 803 to the relay apparatus 200 at the transmission timing. Since the relay apparatus 200 holds the token, the relay apparatus 200 transmits the data 803 as data 804 to the node 2 (202). At this stage, there is little delay between reception of data 803 and transmission of data 804.

In this manner, at this stage, the node 2 (202) can transmit data to the relay apparatus 200 in accordance with the timing at which the relay apparatus 200 transmits data to the node 1 (201). Further, the node 1 (201) can transmit data to the relay apparatus 200 in accordance with the timing at which the relay apparatus 200 holds the token.

Here, it is assumed that a temporary delay has occurred in the network by the token-passing scheme.

Due to this delay, a reception timing of data from the node 2 (202) and a transmission timing of data to the node 1 (201) in the relay apparatus 200 deviate from each other. Therefore, data 806 has not arrived at the relay apparatus 200 at the transmission timing from the relay apparatus 200 to the node 1 (201) (the transmission timing of data 805). Accordingly, the relay apparatus 200 cannot transmit the data 806 and instead, transmits the data 801 as the data 805 to the node 1 (201).

The relay apparatus 200 receives the data 806 and transmits the data 806 as data 807 to the node 1 (201), at the next transmission timing to the node 1 (201). Therefore, a relay delay of about one cycle occurs in the relay apparatus 200 (sign 808). That is, in the relay apparatus 200, a delay at substantially the same level as the transmission interval in the time-triggered scheme has occurred during the time from reception of the data 806 to transmission of the data 807. Unless a cycle time (a communication cycle) in the time-triggered scheme is changed, the delay is maintained thereafter (sign 809).

Further, due to the delay in the network by the token-passing scheme, the reception timing of data from the node 1 (201) and the time while the token is being held in the relay apparatus 200 deviate from each other. Specifically, when data 810 arrives at the relay apparatus 200 from the node 1 (201), the relay apparatus 200 has already released the token. The relay apparatus 200 transmits the data 810 as data 811 to the node 2 (202) after acquiring the token next time. That is, in the relay apparatus 200, a delay at substantially the same level as the reception cycle of the token has occurred during the time from reception of the data 810 to transmission of the data 811 (sign 812). Unless a cycle time (a communication cycle) in the time-triggered scheme is changed, the delay is maintained thereafter (sign 809).

A main object of the present invention is to solve such a problem. More specifically, the main object of the present invention is to provide a configuration in which, when communication is to be relayed between a first communication device that performs communication by the time-triggered scheme and a second communication device that performs communication by the token-passing scheme, even if a communication delay occurs in a network that performs communication by the token-passing scheme, a relay delay can be suppressed without a communication cycle being changed by the first communication device.

### Solution to Problem

A relay apparatus according to the present invention includes:

a first reception unit to receive first data from a first communication device that performs communication by a time-triggered scheme;

a second reception unit to receive second data and a token from a second communication device that performs communication by a token-passing scheme;

a first transmission unit to transmit the second data to the first communication device;

a second transmission unit to transmit the first data to the second communication device while holding the token;

a reference-time management unit to acquire a time from reception of the first data to next reception of the token by the second reception unit as a reference time, when the first reception unit receives the first data while the second transmission unit holds the token; and

a communication control unit to cause the first reception unit to receive the first data repeatedly at a communication cycle equal to or longer than the reference time and shorter than an allowable holding time of the token, causes the first transmission unit to transmit the second data repeatedly at the communication cycle, and every time the token is received by the second reception unit, causes the second transmission unit to hold the token until the second transmission unit transmits the first data to the second communication device within a range of the allowable holding time.

### Advantageous Effects of Invention

In the present invention, every time the relay apparatus receives a token, the relay apparatus holds the token until first data is transmitted to a second communication device within a range of an allowable holding time. Therefore, according to the present invention, even if a communication delay occurs in a network that performs communication by the token-passing scheme, a relay delay can be suppressed without a communication cycle being changed by a first communication device.

### BRIEF DESCRIPTION OF DRAWINGS

FIG. 1 is a diagram illustrating a hardware configuration example of a relay apparatus according to a first embodiment.

FIG. 2 is a diagram illustrating a functional configuration example of the relay apparatus according to the first embodiment.

FIG. 3 is a diagram illustrating a communication sequence for setting a cycle time according to the first embodiment.

FIG. 4 is a diagram illustrating the communication sequence for setting a cycle time according to the first embodiment.

FIG. 5 is a diagram illustrating a communication sequence in a case where a temporary delay occurs in a network by a token-passing scheme according to the first embodiment.

FIG. 6 is a flowchart illustrating an operation example of the relay apparatus according to the first embodiment.

FIG. 7 is a flowchart illustrating an operation example of the relay apparatus according to the first embodiment.

FIG. 8 is a diagram illustrating a relay delay in a case where a temporary delay occurs in the network by the token-passing scheme.

### DESCRIPTION OF EMBODIMENTS

An embodiment of the present invention will be explained below with reference to the accompanying drawings. In the following descriptions and the drawings of the embodiment, elements denoted by the same reference signs indicate the same or corresponding parts.

### First embodiment.

### ***Descriptions of Configurations***

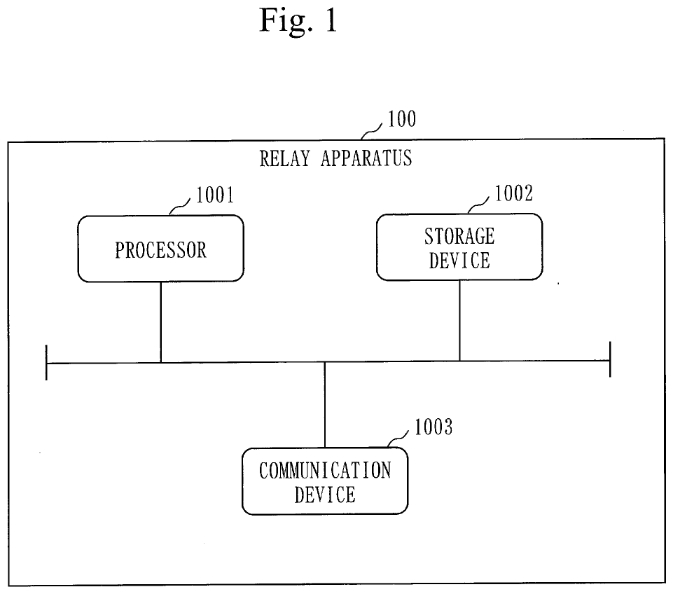

FIG. 1 illustrates a hardware configuration example of a relay apparatus 100 according to the present embodiment.

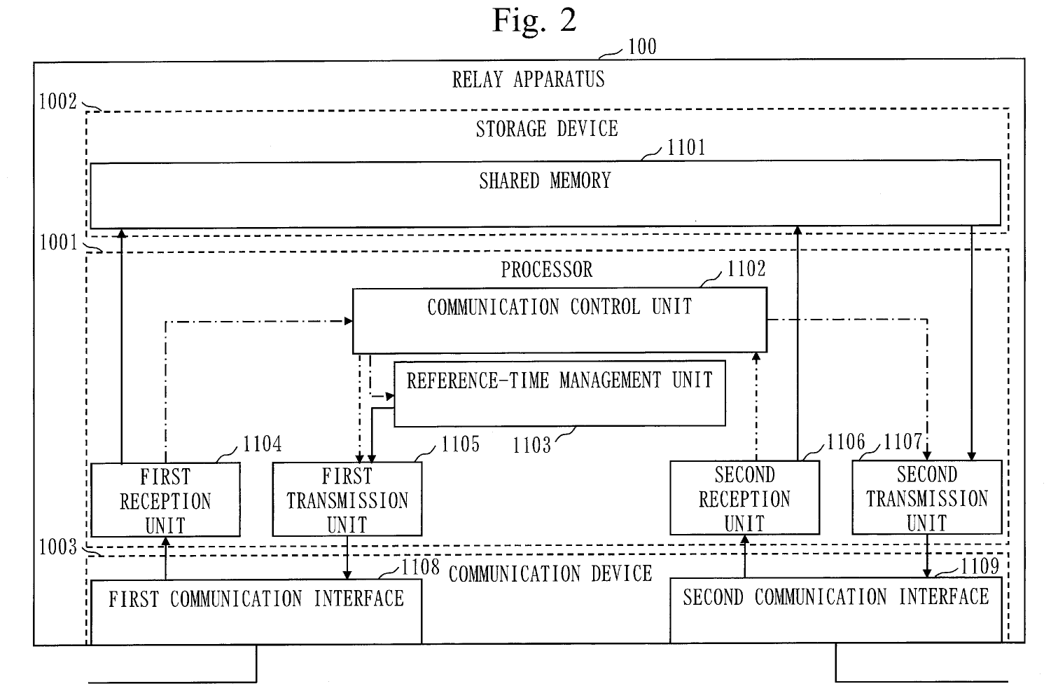

FIG. 2 illustrates a functional configuration example of the relay apparatus 100 according to the present embodiment.

First, the hardware configuration example of the relay apparatus 100 is described with reference to FIG. 1.

The relay apparatus 100 is a computer including a processor 1001, a storage device 1002, and a communication device 1003 as hardware.

The storage device 1002 stores therein programs that realize functions of a communication control unit 1102, a reference-time management unit 1103, a first reception unit 1104, a first transmission unit 1105, a second reception unit 1106, and a second transmission unit 1107 illustrated in FIG. 2.

The processor 1001 executes these programs to perform operations of the communication control unit 1102, the reference-time management unit 1103, the first reception unit 1104, the first transmission unit 1105, the second reception unit 1106, and the second transmission unit 1107.

FIG. 2 schematically illustrates a state where the processor 1001 is executing the programs that realize the functions of the communication control unit 1102, the reference-time management unit 1103, the first reception unit 1104, the first transmission unit 1105, the second reception unit 1106, and the second transmission unit 1107.

As illustrated in FIG. 2, the communication device 1003 includes a first communication interface 1108 and a second communication interface 1109. The first communication interface 1108 is an interface with a network by the time-triggered scheme. The second communication interface 1109 is an interface with a network by the token-passing scheme. In the drawings, the first communication interface 1108 is also noted as I/F 1 and the second communication interface 1109 is also noted as I/F 2.

The operation performed by the relay apparatus 100 corresponds to a relay method and a relay program.

Next, the functional configuration example of the relay apparatus 100 is described with reference to FIG. 2.

A shared memory 1101 stores data therein.

The shared memory 1101 stores therein, for example, data received from a node by the time-triggered scheme, in other words, data to be transmitted to a node by the token-passing scheme. Further, the shared memory 1101 stores therein, for example, data received from the node by the token-passing scheme, in other words, data to be transmitted to the node by the time-triggered scheme.

The shared memory 1101 is realized by the storage device 1002 illustrated in FIG. 1.

The first reception unit 1104 receives data from the node by the time-triggered scheme via the first communication interface 1108.

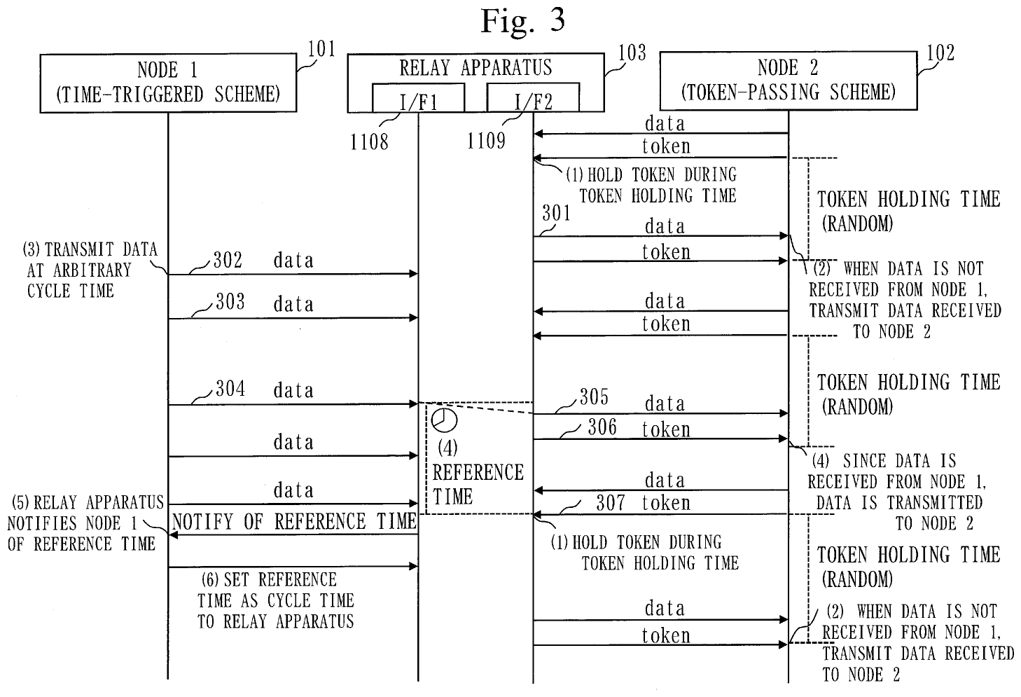

More specifically, the first reception unit 1104 receives data from a node 1 (101) (FIG. 3) that performs communication by the time-triggered scheme. The data received by the first reception unit 1104 is also referred to as first data.

The second reception unit 1106 receives data from the node by the token-passing scheme via the second communication interface 1109.

More specifically, the second reception unit 1106 receives data from a node 2 (102) (FIG. 3) that performs communication by the token-passing scheme. The data received by the second reception unit 1106 is also referred to as second data. Further, the second reception unit 1106 receives a token from the node 2 (102).

The first transmission unit 1105 transmits data to the node by the time-triggered scheme via the first communication interface 1108.

More specifically, the first transmission unit 1105 transmits data received by the second reception unit 1106 (second data) to the node 1 (101).

The second transmission unit 1107 transmits data to the node by the token-passing scheme via the second communication interface 1109.

More specifically, the second transmission unit 1107 transmits data received by the first reception unit 1104 (first data) to the node 2 (102) while holding the token. The second transmission unit 1107 also transmits the token to the node 2 (102).

When the first reception unit 1104 receives first data from the node 1 (101) while the second transmission unit 1107 holds the token, the reference-time management unit 1103 acquires a time from reception of the first data by the first reception unit 1104 to next reception of the token by the second reception unit 1106 as a reference time. More specifically, the reference-time management unit 1103 measures a time after the first reception unit 1104 has received the first data until the second reception unit 1106 receives the token next time as the reference time. The reference-time management unit 1103 notifies the node 1 (101) of the measured reference time via the first transmission unit 1105. In the following descriptions, an example in which the reference-time management unit 1103 measures the reference time is described. However, it is acceptable that an external device performs measurement of the reference time, and the reference-time management unit 1103 acquires a value of the measured reference time from the external device.

An operation performed by the reference-time management unit 1103 corresponds to a reference-time management process.

The communication control unit 1102 is notified of a cycle time decided by the node 1 (101) from the node 1 (101) via the first reception unit 1104. The cycle time is a communication cycle equal to or longer than the reference time and shorter than an allowable holding time of a token.

The cycle time is a cycle in which the node 1 (101) transmits data to the relay apparatus 100 (a cycle in which the relay apparatus 100 receives data from the node 1 (101)). Further, the cycle time is a cycle in which the relay apparatus 100 transmits data to the node 1 (101) (a cycle in which the node 1 (101) receives data from the relay apparatus 100). That is, the node 1 (101) transmits data to the relay apparatus 100 at every cycle time, and the relay apparatus 100 receives data from the node 1 (101) at every cycle time. Further, the relay apparatus 100 transmits data to the node 1 (101) at every cycle time, and the node 1 (101) receives data from the relay apparatus 100 at every cycle time.

Therefore, after the cycle time has been notified from the node 1 (101), the communication control unit 1102 causes the first reception unit 1104 to receive the first data repeatedly at the notified cycle time. Further, the communication control unit 1102 causes the first transmission unit 1105 to transmit the second data repeatedly at the notified cycle time. Every time the second reception unit 1106 receives a token, the communication control unit 1102 causes the second transmission unit 1107 to hold the token until the second transmission unit 1107 transmits the first data to the node 2 (102) within a range of the allowable holding time.

The allowable holding time is a maximum time during which the relay apparatus 100 can hold the token. If the relay apparatus 100 holds the token for a time longer than the allowable holding time, an error occurs.

Further, before the cycle time is notified from the node 1 (101), the communication control unit 1102 causes the first reception unit 1104 to receive the first data transmitted from the node 1 (101) at an arbitrary transmission cycle. Further, before the cycle time is notified from the node 1 (101), every time the second reception unit 1106 receives a token, the communication control unit 1102 causes the second transmission unit 1107 to hold the token until the second transmission unit 1107 transmits the first data to the node 2 (102) within a range of a random time, which is within the allowable holding time.

Further, an allowable time of a communication delay (hereinafter, referred to as allowable delay time) is set in a general token-passing FA network, and if data and the token cannot be received from the node 2 (102) even if the delay time exceeds the allowable delay time, an error occurs.

The communication control unit 1102 also performs management of the allowable delay time. If the data and the token cannot be received from the node 2 (102) within the allowable delay time, the communication control unit 1102 instructs the node 2 (102) to transmit the data and the token.

An operation performed by the communication control unit 1102 corresponds to a communication control process.

***Descriptions of Operations***

Next, a communication sequence according to the present embodiment between the relay apparatus 100 and the node 1 (101) and the node 2 (102) is described with reference to FIGS. 3, 4, and 5.

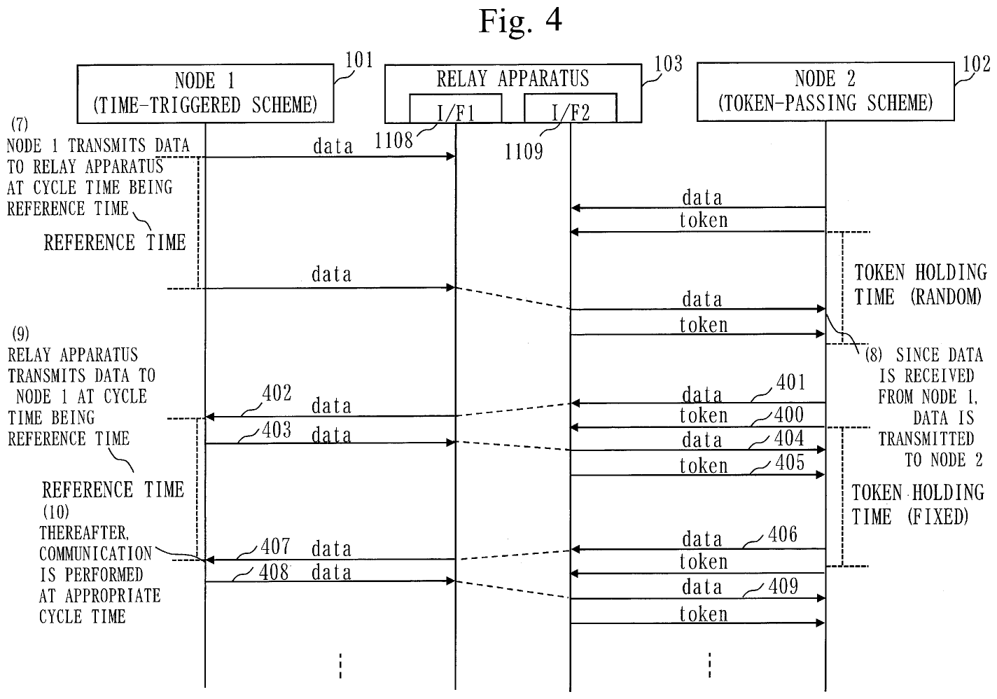

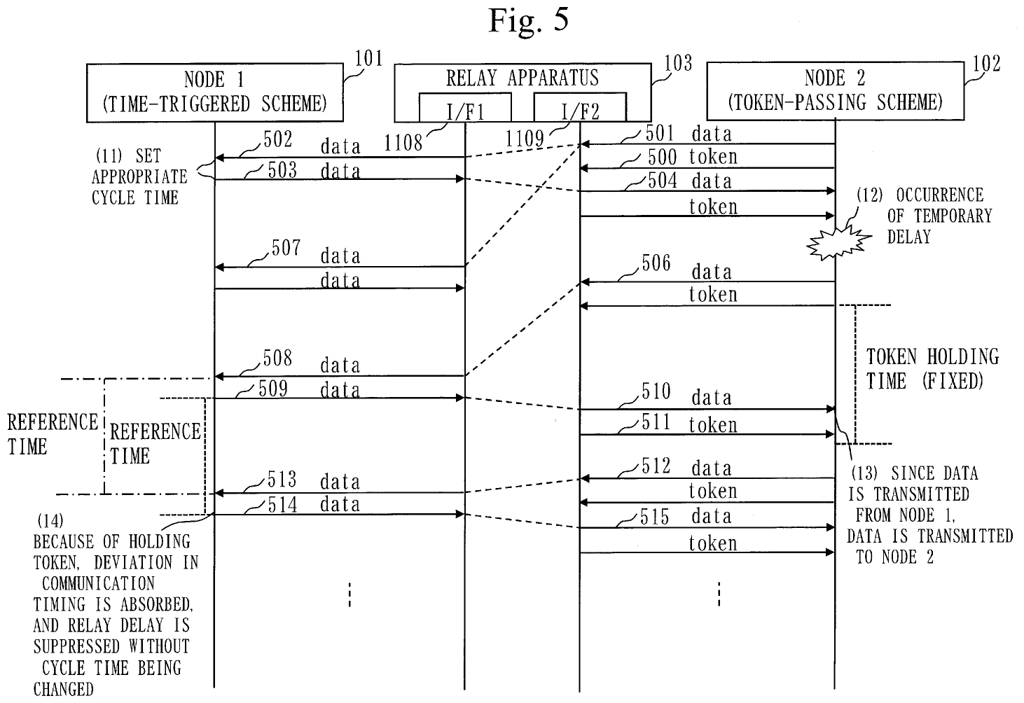

FIGS. 3 and 4 illustrate a communication sequence for setting a cycle time. FIG. 5 illustrates a communication sequence when a temporary delay occurs in a network by the token-passing scheme.

In FIGS. 3, 4, and 5, the node 1 (101) is a communication device compatible with the time-triggered scheme, and corresponds to a first communication device. Further, the node 2 (102) is a communication device compatible with the token-passing scheme, and corresponds to a second communication device.

In FIGS. 3, 4, and 5, only the node 1 (101) is illustrated in the network by the time-triggered scheme. However, it is assumed that nodes compatible with the time-triggered scheme are present other than the node 1 (101). Similarly, in FIGS. 3, 4, and 5, only the node 2 (102) is illustrated in the network by the token-passing scheme. However, it is assumed that nodes compatible with the token-passing scheme are present other than the node 2 (102).

[Communication Sequence 1 (FIG. 3, FIG. 4): Setting of Cycle Time]

FIGS. 3 and 4 illustrate a procedure in which the relay apparatus 100 measures the reference time, and suppresses a relay delay in the relay apparatus 100 by adopting a cycle time (a communication cycle) based on the reference time.

(1) to (10) described below correspond to (1) to (10) illustrated in FIGS. 3 and 4.

(1) When having received a token from the node 2 (102), the relay apparatus 100 receives data from the node 1 (101) and holds the token until the relay apparatus 100 transmits the received data to the node 2 (102) within a range of the allowable holding time.

At this stage (a stage before measurement of the reference time), the communication control unit 1102 decides at random the token holding time in a range shorter than the allowable holding time. The token holding time is a time during which the second transmission unit 1107 holds the token. If the token holding time is a fixed time, a time other than the token holding time is fixed. If the time other than the token holding time is fixed, the timing at which the relay apparatus 100 receives data from the node 1 (101) may become the time other than the token holding time at all times. In order to avoid such a situation, the communication control unit 1102 decides the token holding time at random.

On the other hand, after setting the cycle time, the communication control unit 1102 fixes the token holding time of the second transmission unit 1107 to the allowable holding time.

In the following descriptions, the token holding time to be used before setting of the cycle time, which is a random time, is noted as token holding time (random). Further, the token holding time to be used after the cycle time is set, that is, the allowable holding time is noted as token holding time (fixed).

(2) If data is not received from the node 1 (101) within the token holding time (random), the relay apparatus 100 transmits data which has been received previously to the node 2 (102). That is, the relay apparatus 100 transmits the data which has been received from the node 1 (101) to the node 2 (102) as data 301. Further, the relay apparatus 100 transmits the token to the node 2 (102).

(3) The node 1 (101) transmits data to the relay apparatus 100 at an arbitrary cycle time. Data 302 and data 303 are overwritten by data 304 in the shared memory 1101 of the relay apparatus 100. Therefore, the data 302 and the data 303 are not transmitted to the node 2 (102). Only the data 304 is transmitted to the node 2 (102) as data 305.

(4) When having received data from the node 1 (101) within the token holding time (random), the relay apparatus 100 transmits the data to the node 2 (102). Specifically, the relay apparatus 100 transmits the data 304 to the node 2 (102) as the data 305. The relay apparatus 100 also transmits a token 306 to the node 2 (102). The relay apparatus 100 measures a time from reception of the data 304 from the node 1 (101) to next reception of a token 307 from the node 2 (102) (a reference time). Measurement of the reference time is performed by the reference-time management unit 1103.

(5) The relay apparatus 100 notifies the node 1 (101) of the measured reference time.

(6) The node 1 (101) sets the reference time notified from the relay apparatus 100 to the relay apparatus 100, as a cycle time (a communication cycle).

In the present embodiment, the node 1 (101) functions as a master apparatus of the relay apparatus 100. Therefore, the relay apparatus 100 notifies the node 1 (101) of the reference time, and the node 1 (101) sets the cycle time to the relay apparatus 100. If the node 1 (101) is not the master apparatus of the relay apparatus 100, the relay apparatus 100 may set the cycle time.

When jitter is included in the cycle at which the node 1 (101) transmits data to the relay apparatus 100 and in the cycle at which the relay apparatus 100 transmits data to the node 1 (101), the node 1 (101) may decide the cycle time by adding the jitter to the reference time. Also when jitter is included in the cycle at which the relay apparatus 100 receives a token from the node 2 (102), the node 1 (101) may decide the cycle time by adding the jitter to the reference time. As described above, the cycle time may be equal to or longer than the reference time, so long as it is shorter than the allowable holding time of the token. In FIG. 3, the node 1 (101) sets the reference time as the cycle time to the relay apparatus 100.

(7) The node 1 (101) transmits data to the relay apparatus 100 at the cycle time being the reference time.

(8) When having received data from the node 1 (101) within the token holding time (random), the relay apparatus 100 transmits the data to the node 2 (102). The relay apparatus 100 also transmits the token to the node 2 (102).

Further, when the relay apparatus 100 receives data from the node 1 (101) after the cycle time is set, the token holding time (fixed) is set in the relay apparatus 100.

As described above, the token holding time (fixed) is the allowable holding time of the token.

Thereafter, every time the relay apparatus 100 receives a token from the node 2 (102), the relay apparatus 100 holds the token until data from the node 1 (101) is transmitted to the node 2 (102) within a range of the token holding time (fixed).

In an example of FIG. 4, upon reception of a token 400, the relay apparatus 100 starts to measure the token holding time (fixed). Here, the relay apparatus 100 receives data 403 from the node 1 (101) within the token holding time (fixed) and transmits the received data 403 to the node 2 (102) as data 404. Since the relay apparatus 100 has transmitted the data 404 to the node 2 (102), the relay apparatus 100 transmits a token 405 to the node 2 (102).

(9) The relay apparatus 100 transmits data to the node 1 (101) at the cycle time being the reference time.

After (10), the node 1 (101) and the relay apparatus 100 repeat communication at the cycle time being the reference time. That is, the node 1 (101) repeatedly transmits data to the relay apparatus 100 at the cycle time being the reference time. Further, the relay apparatus 100 repeatedly transmits data to the node 1 (101) at the cycle time being the reference time.

According to the procedure described above, a relay delay in the relay apparatus 100 can be suppressed.

For example, the relay apparatus 100 receives data 401 immediately before the data transmission timing to the node 1 (101). Therefore, the relay apparatus 100 can transmit the data 401 as data 402 to the node 1 (101) without any delay.

Further, the relay apparatus 100 receives the data 403 from the node 1 (101) immediately after the reception timing of the token 400. Therefore, the relay apparatus 100 can transmit the data 403 as the data 404 to the node 2 (202) without any delay. After transmission of the data 404 to the node 2 (102), the relay apparatus 100 transmits the token 405 to the node 2 (102), even if the token holding time (fixed) has not been completed.

[Communication Sequence 2 (FIG. 5) at the Time of Occurrence of Temporary Delay]

As described above, the relay apparatus 100 holds the token received from the node 2 (102) until the relay apparatus 100 transmits data from the node 1 (101) to the node 2 (102), within a range of the token holding time (fixed). Accordingly, even if a temporary delay occurs in the network by the token-passing scheme, the timing of transmission and reception of data and the timing of transmission and reception of the token in the relay apparatus 100 return to a state before an occurrence of the temporary delay. Therefore, a relay delay can be suppressed without the cycle time of the time-triggered scheme being changed.

(11) to (14) described below correspond to (11) to (14) in FIG. 5.

(11) It is assumed that the node 1 (101) and the relay apparatus 100 set an appropriate cycle time according to the procedure illustrated in FIGS. 3 and 4.

(12) A temporary delay occurs in the network by the token-passing scheme.

(13) The relay apparatus 100 holds a token received from the node 2 (102) until the relay apparatus 100 receives data from the node 1 (101) and transmits the received data to the node 2 (102) within a range of the token holding time (fixed). Since the relay apparatus 100 has received data from the node 1 (101) within the token holding time (fixed), the relay apparatus 100 transmits the received data to the node 2 (102). The relay apparatus 100 also transmits the token to the node 2 (102).

(14) The relay apparatus 100 holds the token until the relay apparatus 100 receives data from the node 1 (101) and transmits the received data to the node 2 (102) in (13) described above, thereby, the relay apparatus 100 can absorb a deviation in the communication timing, which is caused due to a temporary delay in the network by the token-passing scheme. Therefore, the relay apparatus 100 can suppress a relay delay without changing the cycle time in the network by the time-triggered scheme.

Before an occurrence of a temporary delay in the network by the token-passing scheme, the relay apparatus 100 receives data 501 immediately before the data transmission timing to the node 1 (101). Therefore, the relay apparatus 100 can transmit the data 501 as data 502 to the node 1 (101) without any delay.

Further, since the relay apparatus 100 receives the data 503 from the node 1 (101) immediately after reception of a token 500, the relay apparatus 100 can transmit the data 503 as data 504 to the node 2 (102) without any delay.

Due to a temporary delay occurred in the network by the token-passing scheme, a reception timing of data from the node 2 (102) and a transmission timing of data to the node 1 (101) in the relay apparatus 100 deviate from each other. As a result, at the transmission timing from the relay apparatus 100 to the node 1 (101) (at the transmission timing of data 507), data 506 has not reached the relay apparatus 100. Therefore, at the transmission timing of the data 507, the relay apparatus 100 cannot transmit the data 506 to the node 1 (101). The relay apparatus 100 transmits the data 501 which has been received in the past as the data 507 to the node 1 (101).

The relay apparatus 100 receives the data 506 and transmits the data 506 as data 508 to the node 1 (101) at the next transmission timing to the node 1 (101). Therefore, a delay occurs in the data transmission to the node 1 (101) due to the delay in the network by the token-passing scheme.

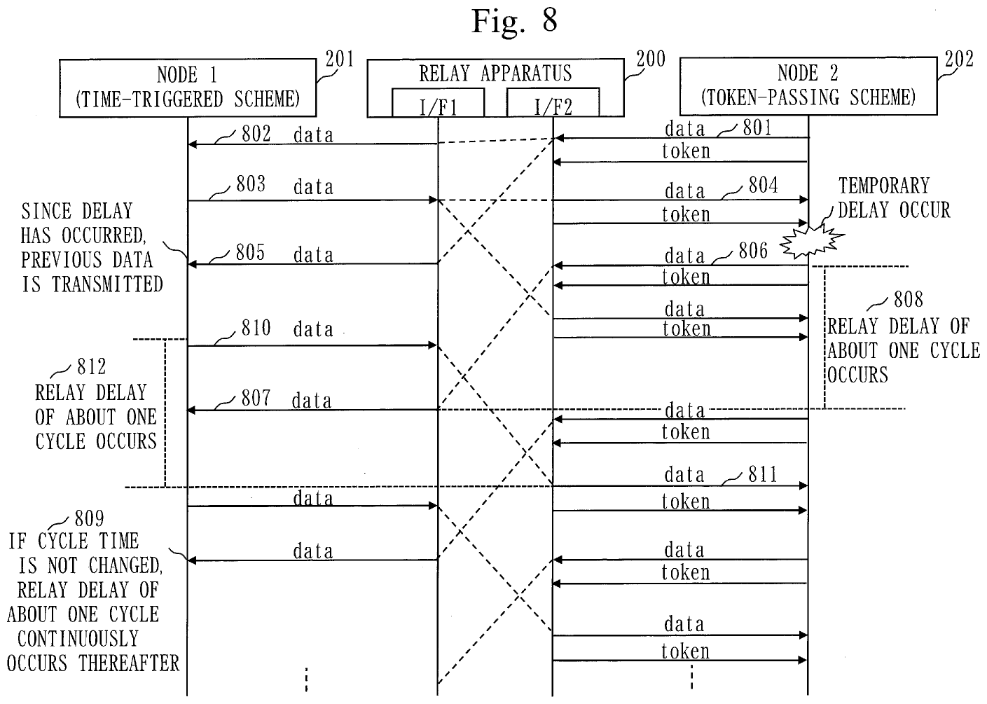

Further, the relay apparatus 100 receives data 509 from the node 1 (101) and transmits the data 509 as data 510 to the node 2 (102). Since the relay apparatus 100 holds the token until reception of the data 509 and transmission of the data 510, the relay apparatus 100 can transmit the data 510 to the node 2 (102) without any relay delay. In the example of FIG. 8, since a relay apparatus 200 does not hold a token at the time of reception of data 810, the relay apparatus 200 transmits the data 810 as data 811 to the node 2 (202) after next reception of the token. Therefore, in the example of FIG. 8, a relay delay occurs in the relay apparatus 200. In the present embodiment, since the relay apparatus 100 holds a token within the allowable holding range, the token is present at the time of reception of the data 509, and the relay apparatus 100 can transmit the data 510.

The relation between the data 510 and a token 511 (a transmission interval) is the same as the relation between the data 404 and the token 405 (a transmission interval) in FIG. 4.

Therefore, as in the relation between data 406 and data 407 in FIG. 4, data 512 in FIG. 5 is transmitted as data 513 to the node 1 (101) without any relay delay. Further, as in the relation between data 408 and data 409 in FIG. 4, data 514 in FIG. 5 is transmitted as data 515 to the node 2 (102) without any relay delay.

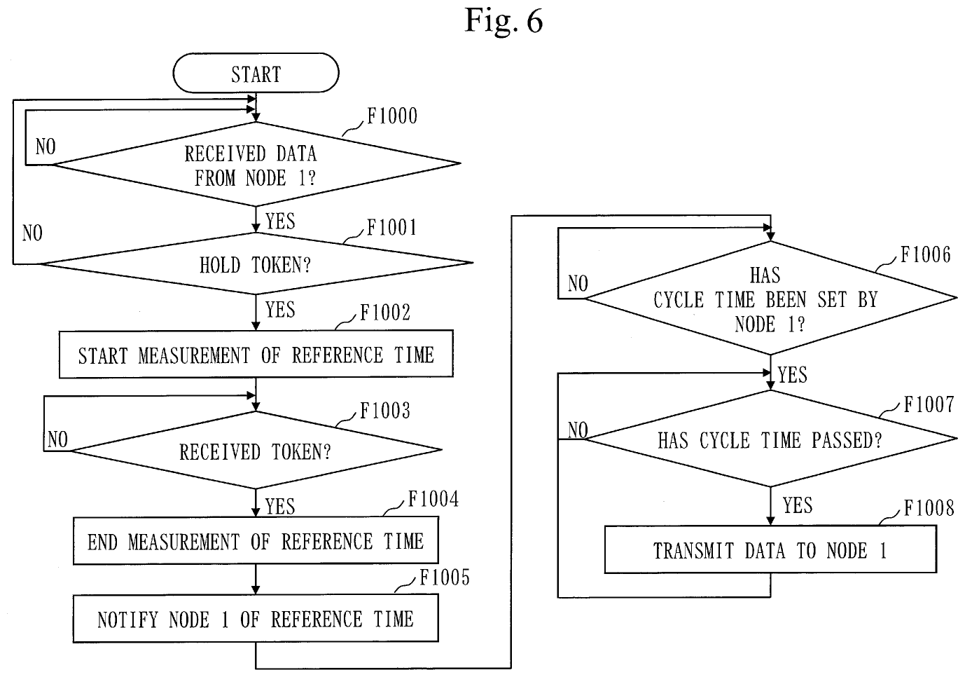

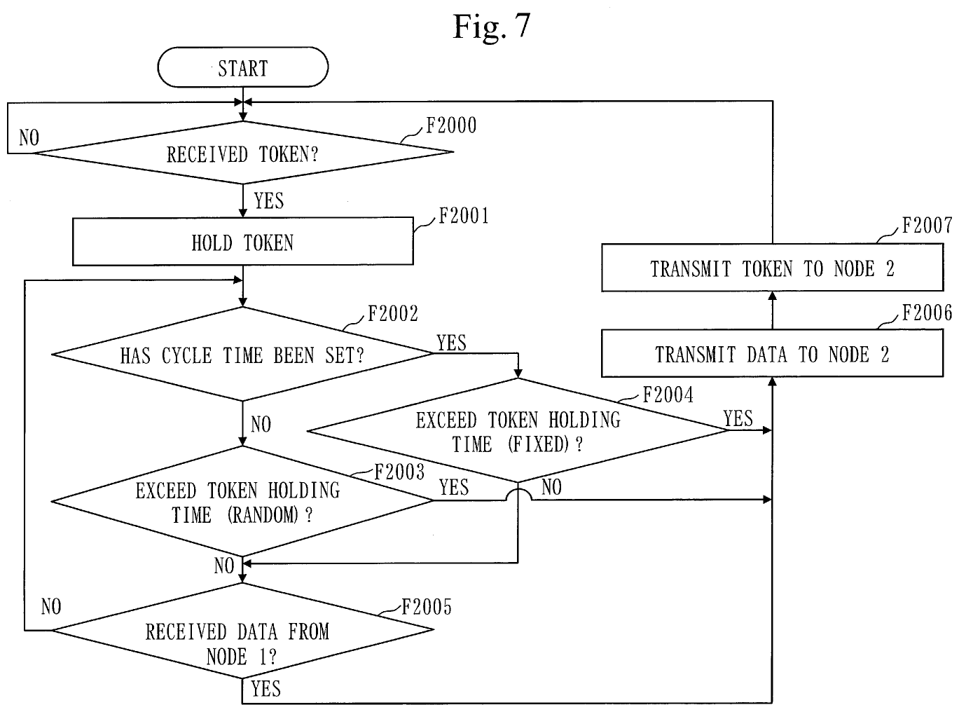

Next, an operation example of the relay apparatus 100 is described with reference to FIGS. 6 and 7.

FIG. 6 illustrates a procedure regarding measurement of the reference time, setting of the cycle time, and transmission and reception of data to/from the node 1 (101).

FIG. 7 illustrates a procedure regarding transmission and reception of data and transmission and reception of a token to/from the node 2 (102).

A flow illustrated in FIG. 6 and a flow illustrated in FIG. 7 are performed in parallel.

First, the flow illustrated in FIG. 6 is described.

In Step F1000, the communication control unit 1102 determines whether the first reception unit 1104 has received data from the node 1 (101). If the first reception unit 1104 receives the data from the node 1 (101), the first reception unit 1104 notifies the communication control unit 1102 of reception of the data from the node 1 (101). Thereby, the communication control unit 1102 can determine whether the first reception unit 1104 has received the data from the node 1 (101). The first reception unit 1104 stores the data received from the node 1 (101) in the shared memory 1101.

When the first reception unit 1104 has received the data from the node 1 (101), Step F1001 is performed.

In Step F1001, the communication control unit 1102 determines whether the second transmission unit 1107 holds a token. Upon reception of a token from the node 2 (102), the second reception unit 1106 notifies the communication control unit 1102 of reception of the token from the node 2 (102). As explained in Step F2007 described later, when a token transmission timing to the node 2 (102) arrives, the communication control unit 1102 instructs the second transmission unit 1107 to transmit the token to the node 2 (102). After being notified that the token is received by the second reception unit 1106, if the communication control unit 1102 has not instructed the second transmission unit 1107 to transmit the token, the communication control unit 1102 determines that the second transmission unit 1107 holds the token.

When the second transmission unit 1107 holds the token, the reference-time management unit 1103 starts measurement of the reference time in Step F1002. That is, when the communication control unit 1102 determines that the second transmission unit 1107 holds the token, the communication control unit 1102 instructs the reference-time management unit 1103 to measure the reference time.

In Step F1003, the communication control unit 1102 determines whether the second reception unit 1106 has received the token. When the second reception unit 1106 has received the token, in Step F1004, the reference-time management unit 1103 ends measurement of the reference time. The reference-time management unit 1103 then notifies the node 1 (101) of the measured reference time via the first transmission unit 1105. As described above, upon reception of the token from the node 2 (102), the second transmission unit 1107 notifies the communication control unit 1102 of the reception of the token from the node 2 (102). Further, when the reception of the token is notified from the second transmission unit 1107, the communication control unit 1102 instructs the reference-time management unit 1103 to end measurement of the reference time. The reference-time management unit 1103 generates data notifying of the measured reference time and transmits the generated data to the node 1 (101) via the first transmission unit 1105.

In Step F1006, the communication control unit 1102 determines whether a cycle time has been set by the node 1 (101). Specifically, upon reception of data notifying of the cycle time from the node 1 (101), the first reception unit 1104 outputs the received data to the communication control unit 1102. The communication control unit 1102 extracts a value of the cycle time from the data and stores the extracted value of the cycle time in a register of the processor 1001.

When the cycle time is set in Step F1006, the communication control unit 1102 determines whether the cycle time has passed in Step F1007. The communication control unit 1102 determines whether the cycle time has passed by performing measurement, for example, using a timer.

When the cycle time has passed, in Step F1108, the communication control unit 1102 instructs the first transmission unit 1105 to transmit data to the node 1 (101), and the first transmission unit 1105 transmits data to the node 1 (101).

More specifically, the first transmission unit 1105 reads out data from the node 2 (102) from the shared memory 1101 and transmits the read data to the node 1 (101).

The flow illustrated in FIG. 7 is described below.

In Step F2000, the communication control unit 1102 determines whether the second reception unit 1106 has received a token from the node 2 (102). As described above, when having received the token, the second reception unit 1106 notifies the communication control unit 1102 of reception of the token. When the communication control unit 1102 determines that the second reception unit 1106 has received the token, the communication control unit 1102 instructs the second reception unit 1106 to output the token to the second transmission unit 1107, and the second reception unit 1106 outputs the token to the second transmission unit 1107. Further, the communication control unit 1102 instructs the second transmission unit 1107 to hold the token.

The second transmission unit 1107 holds the token in Step F2001.

In Step F2002, the communication control unit 1102 determines whether the cycle time has been set. That is, the communication control unit 1102 determines whether a process in Step F1006 in FIG. 6 has been performed.

If the cycle time has not been set, the communication control unit 1102 sets a random time within the allowable holding time as the token holding time (random) to the timer. In Step F2003, the communication control unit 1102 determines whether an elapsed time after reception of the token by the second reception unit 1106 has exceeded the token holding time (random). If the cycle time has been set, the communication control unit 1102 sets the allowable holding time as the token holding time (fixed time) to the timer. Then, in Step F2004, the communication control unit 1102 determines whether the elapsed time after reception of the token by the second reception unit 1106 has exceeded the token holding time (fixed time).

If the elapsed time after reception of the token by the second reception unit 1106 has not exceeded the token holding time (random time), in Step F2005, the communication control unit 1102 determines whether the first reception unit 1104 has received data from the node 1 (101).

Further, also when the elapsed time after reception of the token by the second reception unit 1106 has not exceeded the token holding time (fixed time), in Step F2005, the communication control unit 1102 determines whether the first reception unit 1104 has received data from the node 1 (101).

In Step F2005, when the first reception unit 1104 has received data from the node 1 (101), the communication control unit 1102 instructs the second transmission unit 1107 to transmit the data from the node 1 (101) to the node 2 (102). In Step F2006, the second transmission unit 1107 then transmits the data from the node 1 (101) to the node 2 (102). More specifically, the first reception unit 1104 stores the data from the node 1 (101) in the shared memory 1101 and the second transmission unit 1107 reads out the data from the node 1 (101) from the shared memory 1101. Then, the second transmission unit 1107 transmits the read data from the node 1 (101) to the node 2 (102).

Further, the communication control unit 1102 instructs the second transmission unit 1107 to transmit the token to the node 2 (102). The second transmission unit 1107 transmits the token to the node 2 (102) in Step F2007.

In Step F2003, if the elapsed time after reception of the token by the second reception unit 1106 has exceeded the token holding time (random time), the communication control unit 1102 instructs the second transmission unit 1107 to transmit the data from the node 1 (101) to the node 2 (102). In Step F2006, the second transmission unit 1107 then transmits the data from the node 1 (101) to the node 2 (102). More specifically, the second transmission unit 1107 reads out the data from the node 1 (101) (the data transmitted from the node 1 (101) last time) from the shared memory 1101. The second transmission unit 1107 then transmits the read data from the node 1 (101) to the node 2 (102).

Further, in Step F2004, also when the elapsed time after reception of the token by the second reception unit 1106 has exceeded the token holding time (fixed time), the communication control unit 1102 instructs the second transmission unit 1107 to transmit the data from the node 1 to the node 2 (102). In Step F2006, the second transmission unit 1107 then transmits the data from the node 1 (101) to the node 2 (102). More specifically, the second transmission unit 1107 reads out the data from the node 1 (101) (the data transmitted from the node 1 (101) last time) from the shared memory 1101. The second transmission unit 1107 then transmits the read data from the node 1 (101) to the node 2 (102).

Thereafter, the communication control unit 1102 instructs the second transmission unit 1107 to transmit the token to the node 2 (102). The second transmission unit 1107 transmits the token to the node 2 (102) in Step F2007.

***Descriptions of Effects of Embodiment****

As described above, the relay apparatus according to the present embodiment repeatedly receives first data at a cycle time equal to or longer than a reference time and shorter than an allowable holding time, and repeatedly transmits second data at the cycle time. Further, every time a token is received, the relay apparatus according to the present embodiment holds the token until the relay apparatus transmits the first data to a communication device by the token-passing scheme, within the range of the allowable holding time.

Therefore, according to the present embodiment, an appropriate cycle time can be set, thereby enabling to suppress a relay delay.

Further, even when a temporary delay occurs in the network by the token-passing scheme, a relay delay can be suppressed without the cycle time being changed in a network by the time-triggered scheme.

***Descriptions of Hardware Configuration***

Finally, supplementary descriptions of a hardware configuration of the relay apparatus 100 are provided.

The processor 1001 illustrated in FIG. 1 is an IC (Integrated Circuit) that performs processing.

The processor 1001 is a CPU (Central Processing Unit), a DSP (Digital Signal Processor), and the like.

The storage device 1002 illustrated in FIG. 1 is a RAM (Random Access Memory), a ROM (Read Only Memory), a flash memory, an HDD (Hard Disk Drive), and the like.

The communication device 1003 illustrated in FIG. 1 includes a receiver that receives data and a transmitter that transmits data.

The communication device 1003 is a communication chip or an NIC (Network Interface Card), for example.

Further, in the storage device 1002, an OS (Operating System) is also stored.

At least a part of the OS is executed by the processor 1001.

The processor 1001 executes the programs that realize the functions of the communication control unit 1102, the reference-time management unit 1103, the first reception unit 1104, the first transmission unit 1105, the second reception unit 1106, and the second transmission unit 1107 while executing at least the part of the OS.

The processor 1001 executes the OS, thereby performing task management, memory management, file management, communication control, and the like.

Further, information, data, signal values, and variable values indicating results of processing by the communication control unit 1102, the reference-time management unit 1103, the first reception unit 1104, the first transmission unit 1105, the second reception unit 1106, and the second transmission unit 1107 are stored at least in any of the storage device 1002, and the register and a cache memory in the processor 1001.

Further, the programs that realize the functions of the communication control unit 1102, the reference-time management unit 1103, the first reception unit 1104, the first transmission unit 1105, the second reception unit 1106, and the second transmission unit 1107 can be stored in portable storage medium such as a magnetic disk, a flexible disk, an optical disk, a compact disk, a Blue-ray (registered trademark) disk, and a DVD.

The “unit” of the communication control unit 1102, the reference-time management unit 1103, the first reception unit 1104, the first transmission unit 1105, the second reception unit 1106, and the second transmission unit 1107 can be replaced with “circuit”, “step”, “procedure”, or “process”.

The relay apparatus 100 can be realized by an electronic circuit such as a logic IC (Integrated Circuit), a GA (Gate Array), an ASIC (Application Specific Integrated Circuit), and an FPGA (Field-Programmable Gate Array).

The processors and the electronic circuit described above are also collectively referred to as “processing circuitry”.

### REFERENCE SIGNS LIST

100: relay apparatus; 101: node 1; 102: node 2; 1001: processor; 1002: storage device; 1003: communication device; 1101: shared memory; 1102: communication control unit; 1103: reference-time management unit; 1104: first reception unit; 1105: first transmission unit; 1106: second reception unit; 1107: second transmission unit; 1108: first communication interface; 1109: second communication interface; 200: relay apparatus; 201: node 1; 202: node 2.

1. A relay apparatus comprising:
first reception processing circuitry to receive first data from a first communication device that performs communication by a time-triggered scheme;
second reception processing circuitry to receive second data and a token from a second communication device that performs communication by a token-passing scheme;
first transmission processing circuitry to transmit the second data to the first communication device;
second transmission processing circuitry to transmit the first data to the second communication device while holding the token;
reference-time management processing circuitry to acquire a time from reception of the first data to next reception of the token by the second reception processing circuitry as a reference time, when the first reception processing circuitry receives the first data while the second transmission processing circuitry holds the token; and
communication control processing circuitry to cause the first reception processing circuitry to receive the first data repeatedly at a communication cycle equal to or longer than the reference time and shorter than an allowable holding time of the token, causes the first transmission processing circuitry to transmit the second data repeatedly at the communication cycle, and every time the token is received by the second reception processing circuitry, causes the second transmission processing circuitry to hold the token until the second transmission processing circuitry transmits the first data to the second communication device within a range of the allowable holding time.

2. The relay apparatus according to claim 1,
wherein the reference-time management processing circuitry notifies the first communication device of the reference time, and
the communication control processing circuitry is notified from the first communication device of the communication cycle decided by the first communication device, causes the first reception processing circuitry to receive the first data repeatedly at the communication cycle notified from the first communication device, and causes the first transmission processing circuitry to transmit the second data repeatedly at the communication cycle notified from the first communication device.

3. The relay apparatus according to claim 1,
wherein, until the reference time is acquired by the reference-time management processing circuitry, the communication control processing circuitry
causes the first reception processing circuitry to receive the first data transmitted from the first communication device at an arbitrary transmission cycle, and
every time the token is received by the second reception processing circuitry, causes the second transmission processing circuitry to hold the token until the second transmission processing circuitry transmits the first data to the second communication device within a range of a random time within the allowable holding time.

4. A relay method by a computer including
first reception processing circuitry to receive first data from a first communication device that performs communication by a time-triggered scheme,
second reception processing circuitry to receive second data and a token from a second communication device that performs communication by a token-passing scheme,
first transmission processing circuitry to transmit the second data to the first communication device, and
second transmission processing circuitry to transmit the first data to the second communication device while holding the token, the relay method comprising:
acquiring a time from reception of the first data to next reception of the token by the second reception processing circuitry as a reference time, when the first reception processing circuitry receives the first data while the second transmission processing circuitry holds the token; and
causing the first reception processing circuitry to receive the first data repeatedly at a communication cycle equal to or longer than the reference time and shorter than an allowable holding time of the token, causing the first transmission processing circuitry to transmit the second data repeatedly at the communication cycle, and every time the token is received by the second reception processing circuitry, causing the second transmission processing circuitry to hold the token until the second transmission processing circuitry transmits the first data to the second communication device within a range of the allowable holding time.

5. A non-transitory computer readable medium storing a relay program which causes a computer including
first reception processing circuitry to receive first data from a first communication device that performs communication by a time-triggered scheme,
second reception processing circuitry to receive second data and a token from a second communication device that performs communication by a token-passing scheme,
first transmission processing circuitry to transmit the second data to the first communication device, and
second transmission processing circuitry to transmit the first data to the second communication device while holding the token, to execute:
reference-time management process of acquiring a time from reception of the first data to next reception of the token by the second reception processing circuitry as a reference time, when the first reception processing circuitry receives the first data while the second transmission processing circuitry holds the token, and
communication control process of causing the first reception processing circuitry to receive the first data repeatedly at a communication cycle equal to or longer than the reference time and shorter than an allowable holding time of the token, causing the first transmission processing circuitry to transmit the second data repeatedly at the communication cycle, and every time the token is received by the second reception processing circuitry, causing the second transmission processing circuitry to hold the token until the second transmission processing circuitry transmits the first data to the second communication device within a range of the allowable holding time.
